(19) United States
(12) Patent Application Publication
(10) Pub. No.: US 2007/0181491 A1
(43) Pub. Date: Aug. 9, 2007

(54) Separation apparatus and method

(76) Inventor: Gary Christopher, Glendowie (NZ)

Correspondence Address: RYNDAK & SURI LLP, 200 W. MADISON STREET, SUITE 2100, CHICAGO, IL, 60606, US

(21) Appl. No.: 10/566,951

(22) PCT Filed: Aug. 2, 2004
(86) PCT No.: PCT/NZ04/00170

§ 371 Date: Dec. 4, 2006

(30) Foreign Application Priority Data
Jul. 31, 2003 (NZ) 527318

(51) Int. Cl. B01D 12/00

(52) U.S. Cl. 210/513

(57) ABSTRACT

In its broadest aspect the invention provides apparatus for separation of contaminants from a liquid, said apparatus comprising a gravitational separation means (3) and a screen filter means (11), said screen filter means receiving output from said gravitation separation means (3), and wherein said screen filter (11) means includes woollen fibre.

### TECHNICAL FIELD

This invention relates to separation of contaminants from a liquid, and in particular, though not solely, to an apparatus and process for this purpose.

### BACKGROUND ART

Separation of materials from liquids is a relatively well explored and developed technical field in which improvements are continually being made. However, treatment systems are a constant ongoing subject of research and development in order attempt to refine the processes used to treat such liquids, with particular focus being on simplifying and reducing the associated treatment or pre-treatment costs.

Treatment of liquids such as storm water run-off from road networks, airport runways, or industrial manufacturing operations, which may contain hydrocarbons (in particular petroleum hydrocarbons used within the transport industries), insoluble solids and/or heavy metals, is often required in order to meet the environmental discharge operating conditions and/or to alleviate the loading on municipal treatment works and/or to minimise environmental impact.

In order to remove insoluble materials from liquids, such as grit and heavy metals, gravity-type separators are often utilised. These separators are based on the principle of movement of particles relative to the fluid, where the force exerted on the particles which induces movement is gravity and where the particles are heavier than the suspending liquid. This is essentially a settling operation in which it is necessary that the liquid velocity is kept as low as possible in order to allow the particles sufficient residence time within the vessel (tank or chamber) to settle. The particles which settle are then typically removed from the floor of the vessel by scrapers (or similar means).

A number of the above described settling vessels can be used in series to maximise the particles removed from the liquid, however even this may not remove all particulate matter, especially where the remaining particles are relatively small (fines), and particularly where large flow volumes need to be treated.

Commonly therefore the liquid and remaining unseled solids (these may be fine particles) may then be subjected to removal methods such as precipitation, agglomeration by the addition of flocculating agents, mechanical filtration such as cake filters (utilising filter aids) and/or other mechanical pressure type filtration means, and/or other similar known particulate removal methods.

Filter systems, and in particular screen-type filters, have traditionally been designed to include some porous filter media through which preferably the resistance to flow is constant (although in practice, almost always after a period of filtration there is an increase in the pressure drop across the filter as a consequence of blocking or partial blocking of the filter elements); assuming constant liquid flow and pressure. In general the porous, but resisting, media prevents materials of particular size from passing through to the downstream liquid flow side of the filter. Effectively, such filters provide a grid of pre-determined gap size through which particles of a smaller size may pass, whilst those particles of a greater size can not.

Separation of components from liquids by electrostatic attraction has also been used, however this typically has the disadvantage that the system requires a more complex arrangement and chamber configuration in order to contain the separated components.

It may be advantageous to control the size and type of materials removed from a contaminated liquid feed at each stage of a multi-stage separation process and improvements to the overall system for separation performance, and types of materials able to be separated in addition to the relative control of separation would be desirable. It may also be advantageous to combine a number of separation operations for enhanced separation capabilities. It is an object of the present invention to provide separation apparatus and/or a method of liquid treatment which will go at least some way towards addressing the above issues, and/or to provide the industry with a useful choice.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components which it directly references, but also to other non-specified components or elements. This rationale will also be used when the term ‘comprised’ or ‘comprising’ is used in relation to one or more steps in a method or process.

### DISCLOSURE OF INVENTION

Apparatus for separation of contaminants from a liquid, said apparatus comprising a gravitational separation means and a screen filter means, said screen filter means receiving output from said gravitation separation means, and wherein said screen filter means includes woollen fibre.

Preferably the gravitational separation means includes at least one woollen fibre filter stage.

Preferably the screen filter means comprises a composite of woollen fibre and one or more of the following components:
(i) polypropylene fibre
(ii) polyester fibre
(iii) other synthetic fibre

Preferably the screen filter means comprises a composite of woollen fibre and two other components in a ratio of approximately 80:10:10 respectively on a dry weight basis.

Preferably the filter of the gravitational separation means comprises a composite of woollen fibre and one or more of the following components:
(i) polypropylene fibre
(ii) polyester fibre
(iii) other synthetic fibre

Preferably the filter of the gravitational separation means comprises a composite of woollen fibre and two other components in a ratio of 80:10:10 respectively on a dry weight basis.

Preferably the screen filter means comprises a plurality of screen filters, each progressively denser in the direction of flow of the liquid than the next. Desirably the fibres of each of the screen filters are carded and/or twisted and/or warped and/or knitted and/or felted.

Preferably, the apparatus is configured to provide a circular flow path for the liquid. Alternatively the apparatus is configured to provide a snaking flow path for the liquid between an aligned inlet and outlet.

Preferably, a series of connected concentric circular chambers are provided which house the gravitational separation means and the screen filter means. Alternatively the chamber or chambers housing the gravitational separation means precede the chamber or chambers housing the screen filter means in a linear sequence spaced between the aligned inlet and outlet.

Preferably, said screen filter means are provided in a screen filter means chamber or chambers which is or are concentric with a gravitational separation means chamber or chambers in which said gravitational separation means are provided.

Preferably, the direction of flow in the screen filter means chamber or chambers is opposite to the direction of flow in the gravitational separation means chamber or chambers.

Preferably a plurality of gravitational separation means are provided, each of which are provided in respective gravitational separation means chambers, adjacent one of which are connected by a conduit extending from substantially at the liquid surface of a first chamber to substantially at the floor of the adjacent downstream chamber, and wherein a most upstream gravitational separation means chamber is provided with an inlet port.

Preferably the screen filter means are provided in the form of at least one screen filter means chamber including at least one screen filter of said at least one screen filter means chambers adapted to receive the output from a gravitational separation means chamber.

Preferably the apparatus is configured and arranged to, in use, maintain a static liquid head in each of said gravitational separation means chamber or chambers and screen filter means chamber or chambers to such as to maintain the filter of the gravitational separation means and the screen filter means, respectively, in a substantially wetted condition.

In a further aspect, the invention may broadly be said to comprise an apparatus for separation of contaminants from liquids including:
at least two connected primary chambers which operate as gravitational separators, wherein a first chamber has an inlet port and a connecting conduit to a second chamber, and
at least two connected secondary chambers each separated by a screen filter comprising a composite filter material, wherein a first of said secondary chambers receives output from the most downstream chamber and the most downstream of said secondary chambers discharges treated liquid.

Preferably the two primary chambers are connected in series, the inlet to the apparatus feeding into a first of the primary chambers which is then connected to the second of the two primary chambers via one or more pipes configured in the nature of an inverted periscope skimmer to allow transfer of floating material from the first primary chamber to the second whilst maximising retention of non floating separated material.

Preferably the apparatus includes a third primary chamber connected to the second primary chambers via one or more pipes configured in the nature of an inverted periscope skimmer to allow transfer of floating material from the second primary chamber to the third, said third primary chamber containing a composite fibre filter for the adsorption of petroleum hydro carbons, and the absorption of heavy metals and some other suspended particular material.

Preferably the third primary chamber is connected via a pipe to the first of the secondary chambers.

In still a further aspect, the invention may broadly be said to consist of a method of liquid treatment using a separation apparatus substantially as described in the first aspect, said method comprising the steps of:
(i) transporting the liquid to be treated to the gravitational separation means and processing the liquid, and
(ii) transporting the liquid from step (i) to the screen filter means for further treatment and then discharging the liquid.

### BRIEF DESCRIPTION OF DRAWINGS

Further aspects of the present invention will become apparent from the following description which is given by way of example only and with reference to the accompanying drawings in which:

FIG. 1 illustrates separation apparatus in accordance with a first embodiment of the present invention;

FIG. 2 is a process flow diagram of separation apparatus in accordance with an embodiment of the present invention;

FIG. 3 is a plan view of an alternative embodiment of the present invention; and

FIG. 4 is a side elevation of the embodiment of the invention illustrated in FIG. 3.

### BEST MODES FOR CARRYING OUT THE INVENTION

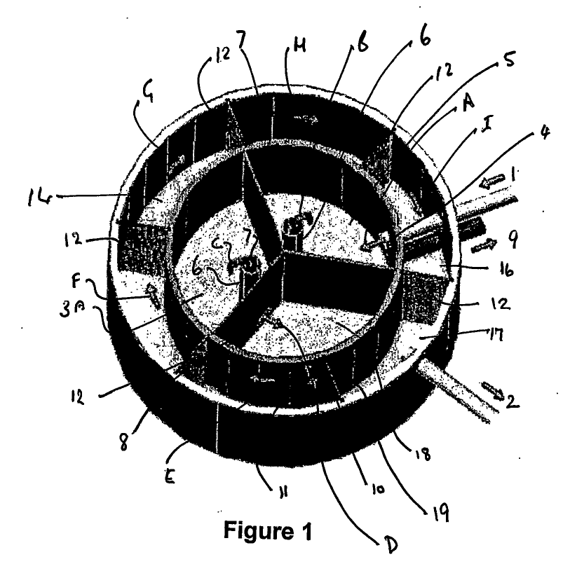

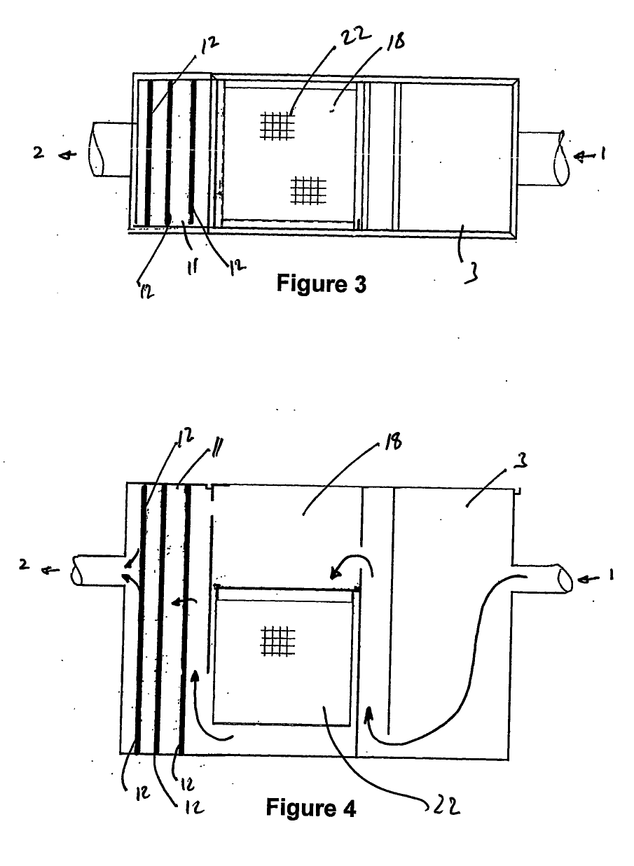

Separation apparatus configurations as shown in FIG. 1, or in FIGS. 3 and 4, may be utilised in order to separate materials (or contaminants) from a liquid for further use and/or treatment. In the drawings like components have been like numbered.

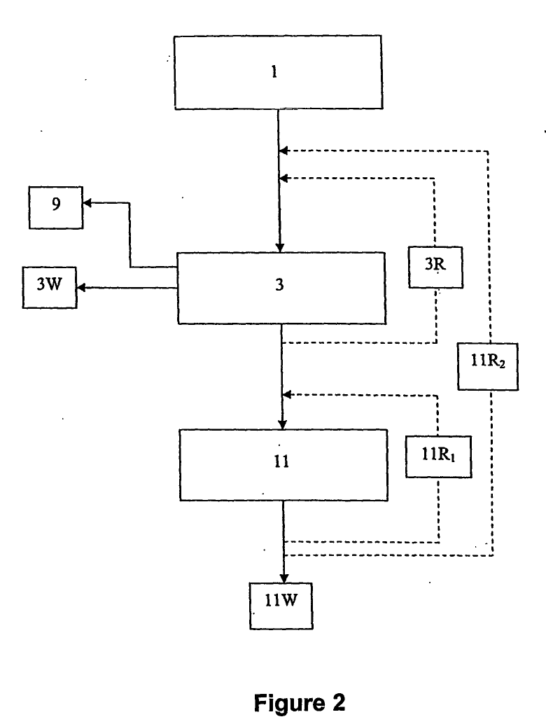

A process as outlined in FIG. 2 may be provided as a treatment process whereby a contaminated liquid input stream 1 fed into the process may result in a liquid output stream 2 including reduced contaminant matter.

Contaminants which may be entrained within the liquid feed 1 may be materials as are often found in typical run-off from road networks, airports, industrial operations or manufacturing processes and/or from municipal or industrial attachments or similar facilities. For example, this may also include run-off or spillage from bunded or dyked areas around the bases of reactor or storage vessels.

In order to help separate these sorts of materials from a liquid, the apparatus shown in FIG. 1 and/or the process as illustrated in FIG. 2 and described herein below may be used.

The contaminants separated by the present invention may be hydro carbonaceous (in particular petroleum hydrocarbons), insoluble materials (particles), heavy metals, and both polar and non-polar type materials. For example, diesel, petrol, arsenic, volatile organic compounds 9VOC) and semi volatile organic compounds (SVOC) and suspended solids. These may all be typically found in storm water runoff from roofs, roads and paved areas. Preferably, the system as herein described is utilised to treat such runoff, particularly able to treat large volumes of liquid.

The contaminants may be separated and either discharged at outlet 2 or sent for further processing by other methods, for example mechanical, electrical or chemical operations.

Preferably, the liquid output 2 from this system provides a useful separation process which operators can use to either help reduce the loading placed on municipal treatment works, or to help comply with discharge regulations.

A contaminated liquid 1 is collected from a catchment area, such as an airport runway system, road sewers, spillway collections and transported (perhaps by tanker or piping network) and fed to a gravitational separation means 3, preferably in the form of settling separation chamber(s) 3. In the gravity separation chamber 3 the velocity of the liquid is preferably minimised, however compared to other more traditional type gravity separators, the configuration of this chamber is improved and allows for generally reduced required residence time for particles to separate and settle.

Referring more specifically to the embodiment of FIG. 1, the liquid feed to the first chamber 3 is installed preferably at a position 4 low on the chamber wall 5. The gravitational or settling chamber is divided into a plurality of compartments or more than one gravitational or settling chamber may be provided, adjacent ones of which are connected in series by, for example, conduits 6 which have an open end 7 to receive liquid and buoyant or floating material from substantially at or near the liquid surface in the upstream gravitational chamber, and an outlet port 8 (not shown in the second chamber 3A, but shown in the third chamber 18) within a downstream chamber, wherein the outlet port 8 is located at a substantially low point on the second chamber wall or substantially near floor level. Conduits 6 may be referred to as ‘periscope riser’.

The periscope riser configuration allows for materials which float or are particularly buoyant to be transported from one chamber to the next (these materials may be agglomerated or individual particle matter). These buoyant materials are transported from gravity chamber to gravity chamber quickly, whereas heavier materials tend to fall to the floor of the gravity chambers (these particles may form a sludge and are subsequently removed from the floor by mechanical scrapers or the like). The periscope riser may also include one or more mesh grills to deflect bulk solids back into the chamber 3.

As buoyant materials are quickly removed and transported to the next downstream gravity chamber, this allows further available retention/residence time for the non-buoyant materials in which to settle out. Depending on the mass loading of the liquid with buoyant to non-buoyant materials, and the liquid flow rate, the residence time available is also influenced (as the suspended mass of material within the liquid preferably reduces at each chamber).

This gravity separation chamber configuration may be repeated in series as shown in FIG. 1 (or alternatively parallel) as many times as is necessary to provide an effective separation of non-buoyant matter from the contaminated liquid. The type of chamber configuration may also be determined somewhat by the necessary maximum operational volume to be treated (m3.s-1).

The first chamber 3 may also include an overflow conduit or facility 9, able to engage and cope with liquid not being processed, for instance during maintenance operations or when inflow to the system exceeds the processing capability (this may be as a result of increased resistance to flow by the screen filters, which will soon be discussed, after a period of operation). During overflow situations, the liquid may be re-directed to a holding vessel and stored temporarily until it may be processed.

The first chamber 3 (and subsequent chambers) may also include a deflection plate or bottle (not shown) at the liquid inlet point 4 to help create a pre-determined flow path within the chamber to help reduce liquid velocity. In addition, a coalescing plate (also not shown) may also be implemented to help control the liquid flow and directs liquid toward the periscope riser to reduce the residence time necessary for gravity separation of solids from buoyant materials.

The output of the liquid treated from the gravity separation chambers 3, 3A, 18 is discharged at outlet 10 and then enters a screen filter chamber 11 for final treatment and processing prior to final discharge at outlet 2. Baffle 19 ensures that liquid entering chamber 11 is caused to flow in the direction of screen filter 12. The screen filter or filters 12 provides adsorption and/or absorption capabilities, and may comprise or include woollen fibre. One or more screen filters 12 and series or parallel arranged chambers (11, 13, 14, 15, 16, 17) may be employed to contact the liquid output 10 from the gravity separation stage 3, and may effect containment of fine particles (or hydrocarbons etc) not already contained within the gravity separation stage, and other particles carried with the liquid in suspension or as solute.

The fibre used for the filter stages may include woollen fibre which has been treated (for example, a woollen fleece is scoured, and the natural greases are removed leaving a fibre capable of absorption of not only greases and oils, but small molecular solids) to be carded and/or twisted and/or knitted and/or slumped and/or knapped or woven to help enhance the potential liquid to fibre surface contact. The fibres are a scaly material, such that each strand of fibre may be coated with hooks or scales or similar particle grabbing means to help contain contaminants within the filter fibres. A desirable operation of the fibres may be that in particular hydro carbons (especially petroleum hydrocarbons) are contained within the filter fibre.

The fibre filters also may include polypropylene and/or polyester micro-fibre or other scaly material or woolly type fibre materials. Polypropylene fibres have some ability to absorb materials, whilst the polyester is mainly provided as a deflection agent to reflect and bounce materials towards woollen fibres for absorption.

The density of the screen filters may vary depending upon the flow requirements and liquid conditions, or necessary material containment by the filters from the liquid being treated. Additionally, the fibre blends and ratios of each fibre component may be adjusted from application to application as required, and may be determined by the specific contaminants being targeted for removal from the liquid. For example, a typical urban road run off fibre blend may be woollen fibre 80%, polypropylene micro fibre 10% (on a dry weight basis).

For example, generally where molecular solids are of sizes greater than 120 pm, the quantity of polypropylene and polyester is reduced (to less than 10% by dry weight each), and where the solids are less than 120 pm, the quantity of polypropylene and polyester is increased (to a maximum of 10% by dry weight.

The flow path of the liquid through the filters is such that the opportunities for the particles, or other contaminants, to contact the woollen fibre (or other fibre of the filter) are enhanced, which may be as a result of the convoluted flow pathway through the fibre filter. The filtered liquid may then be discharged at outlet 2 or sent for further processing, such as by mechanical, electrical or chemical methods or to other suitable treatment facilities.

The final gravity separation chamber 18 may include a fibre filter (not shown in FIG. 1, but illustrated in FIGS. 3 and 4), which generates minimal head loss in the system, and provides an initial filtering treatment stage. This initial filtering stage contains materials such as hydro carbonaceous matter.

The screen filter stage may include and utilise more than one screen filter, with the screen filters may have an increasing degree of fibre density (and increased complexity of convoluted flow path for the liquid being treated) The woollen fibres are treated to be warp knit felt sleeves. The screen filters may be progressively denser than the previous upstream screen when more than one screen filter is used. The denser the filters become, the greater the opportunity for suspended solids or other contaminants to contact the fibre and be contained. In an alternative configuration, the screen filter stages may be configured and/or sized to allow liquid to overflow the screen filter in cases where the filters become blocked (“blind-off”). A passage over the screen may be a weir spillway to reduce the possibility recharge of material already contained in the screen filter back into the liquid. This feature may enhance the life cycle performance of the overall system.

The gravity separation chamber(s) and screen filter chamber(s) may be configured to form a circular arrangement as shown in FIG. 1 with the contaminated liquid entering the chamber at 4 and flowing from gravity separation chamber to gravity separation chamber, via the periscope risers 6, contra to the flow direction of the liquid being processed in the screen filter chambers 11 as shown by arrows A-E, and F-L. It may be an advantage of the circular or concentric configuration to allow optimised space usage and/or the option of constructing the above described liquid treatment process and apparatus in a concrete or hi-density polyethylene tank (or similar) and may have advantages where available construction space is minimal. This arrangement may also benefit from a slight “centrifugal” separation component.

The apparatus and process may be configured to include recycle loops from various treatment chamber stages to allow the ability for continuous and refined liquid processing. For example, the process flow diagram as shown in FIG. 2 shows some possible recycle streams available. Stream 3R is a recycle of liquid from the gravity separation chamber stage 3, and may be used where particularly heavy mass loading of liquid 1 has occurred and it provides an advantage to re-process the liquid more than once through the gravitational or settling chambers. Similarly, recycle streams 11R1 and 11R2 provide the ability to recycle output 2 from the screen filter stage 11 to be either re-processed in the screen filter chambers(s) 11 or enter the gravity separation chamber(s) 3 respectively.

Stream 3W may be material removed by scrapers (or similar means) from the gravity separation chamber(s) 3, 3A, 18 and may, for example, be sent to landfill for further treatment systems. Similarly, stream 11W may be either discharged directly to the environment, or sent further treatment, for example, at a municipal waste treatment facility.

The apparatus may be located at pipe work outfalls and subjected to tidal flows or surcharge, and advantageously the contaminants contained within the filter fibre are not dislodged, even though liquid flow may be reversed through the system. Preferably, the blend and configuration of fibre provides secure and stable adhesion/containment of contaminants, even when subjected to reverse liquid flow.

The arrangement of FIGS. 3 and 4 is such as to provide an inline flow path which facilitates potentially greater liquid flow rates that is permitted by the construction described above with reference to FIG. 1. In this arrangement the inlet and outlet are located in substantial alignment with the top of the fibre filter 22 of the second gravity separation chamber. A monofilament sack (not shown) may be fitted over the entry of the inlet pipe into the first gravity separation chamber to remove bulk solid items.

The fibre filter of the second gravity separation chamber is of the construction described above, and is housed with a monofilament bag, which in turn is captured within a steel mesh framework.

A further advantage of the present invention is the substantially biodegradable aspect of the filter fibre. This may be particularly advantageous once the used fibre filter(s) have been removed from the system, and require disposal (for example in a landfill). The screen filter stage may also be constructed to enable wetland plants to effectively camouflage the system, and may also assist somewhat with the treatment of liquids, or to some degree help in processing liquid.

Aspects of the present invention have been described by way of example only and it should be appreciated that modifications and additions may be made thereto without departing from the scope thereof.

1. Apparatus for separation of contaminants from a liquid, said apparatus comprising a gravitational separation chamber housing a gravitational separation means and a screen filter chamber housing a screen filter means, said screen filter chamber receiving output from said gravitation separation chamber means, and wherein said screen filter means includes woollen fibre and one or more of the following components:
(i) Polypropylene fibre
(ii) Polyester fibre
(iii) other synthetic fibre.

2. Apparatus according to claim 1 wherein the gravitational separation means includes at least one woollen fibre filter stage comprised of woollen fibre and one or more of the following components:
(i) Polypropylene fibre
(ii) Polyester fibre
(iii) other synthetic fibre.

3. (canceled)

4. Apparatus according to claim 1 wherein the screen filter means comprises a composite of woollen fibre and two other components in a ratio of approximately 80:10:10 respectively on a dry weight basis.

5. (canceled)

6. Apparatus according to claim 2 wherein the filter of the gravitational separation means comprises a composite of woollen fibre and two other components in a ratio of approximately 80:10:10 respectively on a dry weight basis.

7. Apparatus according to claim 1 wherein the screen filter means comprises a plurality of screen filters, each progressively denser in the direction of flow of the liquid than the next.

8. Apparatus according to claim 7 wherein the fibres of each of the screen filters are carded and/or twisted and/or warped and/or knitted and/or felted.

9. Apparatus according to claim 1 configured to provide a circular flow path for the liquid.

10. Apparatus according to claim 1 configured to provide a snaking flow path for the liquid between an aligned inlet and outlet.

11. Apparatus according to claim 9 wherein a series of connected concentric circular chambers are provided which house the gravitational separation means and the screen filter means.

12. Apparatus according to claim 10 wherein the chamber or chambers housing the gravitational separation means precede the chamber or chambers housing the screen filter means in a linear sequence spaced between the aligned inlet and outlet.

13. Apparatus according to claim 9 wherein said screen filter means are provided in a screen filter means chamber or chambers which is or are concentric with a gravitational separation means chamber or chambers in which said gravitational separation means are provided.

14. Apparatus according to claim 13 wherein the direction of flow in the screen filter means chamber or chambers is opposite to the direction of flow in the gravitational separation means chamber or chambers.

15. Apparatus according to claim 14 wherein a plurality of gravitational separation means are provided, each of which are provided in respective gravitational separation means chambers, adjacent one of which are connected by a conduit extending from substantially at the liquid surface of a first chamber to substantially at the floor of the adjacent downstream chamber, and wherein a most upstream gravitational separation means chamber is provided with an inlet port.

16. (canceled)

17. Apparatus according to claim 1 wherein the apparatus is configured and arranged to, in use, maintain a static liquid head in said gravitational separation means chamber and said screen filter chamber to maintain the filter of the gravitational separation means and the screen filter means, respectively, in a substantially wetted state.

18. Apparatus according to claim 1 for separation of contaminants from liquids including:
at least two connected primary chambers which operate as gravitational separators, wherein a first chamber has an inlet port and a connecting conduit to a second chamber, and
at least two connected secondary chambers each separated by a screen filter comprising a composite filter material, wherein a first of said secondary chambers receives output from the most downstream chamber and the most downstream of said secondary chambers discharges treated liquid.

19. Apparatus according to claim 18 wherein the two primary chambers are connected in series, the inlet to the apparatus feeding into a first of the primary chambers which is then connected to the second of the two primary chambers via one or more pipes configured in the nature of an inverted periscope skimmer to allow transfer of floating material from the first primary chamber to the second whilst maximising retention of non floating separated material.

20. Apparatus according to claim 19 further including a third primary chamber connected to the second primary chambers via one or more pipes configured in the nature of an inverted periscope skimmer to allow transfer of floating material from the second primary chamber to the third, said third primary chamber containing a composite fibre filter for the adsorption of petroleum hydro carbons, and the absorption of heavy metals and some other suspended particular material.

21. Apparatus according to claim 20 wherein the third primary chamber is connected via a pipe to the first of the secondary chambers.

22. A method of liquid treatment using a the separation apparatus of claim 1 , said method comprising the steps of:
(i) transporting the liquid to be treated to the gravitational separation means and processing the liquid, and
(ii) transporting the liquid from step (i) to the screen filter means for further treatment and then discharging the liquid.

23. (canceled)

24. (canceled)
